(19) United States
(12) Patent Application Publication
(10) Pub. No.: US 2025/0348847 A1
(43) Pub. Date: Nov. 13, 2025

(54) Employee Operational And Administrative Actions Based On Time Entry And Biometrics

(71) Applicant: Harri (US) LLC, New York, NY (US)

(72) Inventor: Luke Peter Fryer, New York, NY (US)

(73) Assignee: Harri (US) LLC, New York, NY (US)

(21) Appl. No.: 18/951,889

(22) Filed: Nov. 19, 2024

Related U.S. Application Data
(60) Provisional application No. 63/645,274, filed on May 10, 2024.

(51) Int. Cl. G06Q 10/1091; G06Q 40/12

(52) U.S. Cl. CPC G06Q 10/1091; G06Q 40/125

(57) ABSTRACT

Aspects of the disclosure are directed to managing operational and/or administrative actions for employees with dynamic attendance tracking. Dynamic attendance tracking includes a biometric scanner and employee database. The biometric scanner scans the employee to identify the employee and the time the employee clocked in and clocked out. The employee database stores identification information about the employee to determine whether to output additional actions or operations for that employee when that employee clocks in and clocks out.

### CROSS-REFERENCE TO RELATED APPLICATIONS

The present application claims the benefit of the filing date of U.S. Provisional Patent Application No. 63/645,274, filed May 10, 2024, the disclosure of which is hereby incorporated herein by reference.

### BACKGROUND

Organizations, such as companies or corporations, use time tracking systems to manage when their employees are working. Typically, each day employees clock in at the time tracking system when they start work and clock out at the time tracking system when they finish work. The employees may clock in and clock out by placing an identification card near the time tracking system or entering a personal identification number (PIN) into the time tracking system. The time tracking system can then store each time that the employees clocked in and clocked out. The organization can use the clock in and clock out times to determine attendance, payroll, and/or otherwise manage their employees. However, these time tracking systems are typically limited to time entry. Further, having employees clock in and out using identification cards does little to prevent fraudulent behavior, such as an employee clocking in for multiple employees using the other employees' identification cards, even if those other employees are not present.

### BRIEF SUMMARY

Aspects of the disclosure are directed to managing operational and/or administrative actions for employees with dynamic attendance tracking. Rather than an employee clocking in and clocking out with an identification card or PIN simply for time entry, the dynamic attendance tracking includes a biometric scanner and employee database storing employee profiles. The biometric scanner scans the employee to identify the employee and the time the employee clocked in and clocked out. The employee database stores identification information about the employee to determine whether to output additional actions or operations for that employee when that employee clocks in and clocks out. For example, an employee can clock in using facial identification and, based on the employee identified, a document may be output for the identified employee to sign. As another example, the employee can clock in using facial identification and, based on the employee identified, a notice may be output congratulating the employee on a work anniversary. The dynamic attendance tracking can streamline databases storing employee information and time entry, resulting in less memory usage in employee management systems.

An aspect of the disclosure is directed to a method for providing actions or notifications to an employee clocking in or clocking out. The method may comprise receiving, by one or more processors, biometric data associated with the employee. The one or more processors may verify an identity of the employee using the biometric data, determine that at least one of an action or notification is associated with the employee based on the biometric data; and output the action or notification.

In some instances, the biometric data comprises at least one of ocular data, facial data, or fingerprint data.

In some instances, the method may include receiving metadata comprising at least one of a timestamp or location for when or where the employee is clocking in or clocking out.

In some instances, the action or notification is output as part of a confirmation that the employee clocked in or clocked out.

In some instances, verifying the identity of the employee comprises comparing the biometric data with baseline data representing the employee. In some examples, verifying the identity of the employee comprises determining biometric data matches the baseline data within a threshold amount. In some examples, determining that at least one of an action or notification is associated with the employee further comprises searching an employee database for actions or notifications associated with the baseline data that matched with the biometric data. In some examples, the baseline data comprises historical biometric data associated with the employee.

In some instances, verifying the identity of the employee comprises entering a timestamp when the identity was verified to represent a time the employee clocked in or clocked out.

In some instances, the method includes receiving, by the one or more processors, second biometric data associated with an individual, comparing, by the one or more processors, the second biometric data with baseline data; and, determining, by the one or more processors, that the second biometric data does not match the baseline data within a threshold amount.

In some instances, the method includes outputting, by the one or more processors, an error message that an identity of the individual cannot be verified.

In some instances, the actions or notifications comprise at least one of documents to sign, surveys to complete, training sessions or compliance attestation to schedule or complete, engagement actions to perform, communications to transmit, recognition events, performance management processes, announcement notifications, birthday notifications, or work anniversary notifications.

In some instances, the actions or notifications comprise a detection of fraudulent behaviors with respect to the employee clocking in or clocking out.

In some instances, the method includes receiving, by one or more processors, third biometric data associated with a second employee; verifying, by the one or more processors, an identity of the second employee using the third biometric data; determining, by the one or more processors, there are no actions or notifications associated with the second employee based on the third biometric data; and outputting, by the one or more processors, a confirmation that the second employee clocked in or clocked out.

Another aspect of the disclosure is directed to a system comprising one or more processors and one or more storage devices coupled to the one or more processors. The one or more storage devices may store instructions that, when executed by the one or more processors, cause the one or more processors to perform operations for providing actions or notifications to an employee clocking in or clocking out, the operations comprising: receiving biometric data associated with the employee; verifying an identity of the employee using the biometric data; determining that at least one of an action or notification is associated with the employee based on the biometric data; and outputting the action or notification.

In some instances, the biometric data comprises at least one of ocular data, facial data, or fingerprint data.

In some instances, verifying the identity of the employee comprises: comparing the biometric data with baseline data representing the employee; and determining biometric data matches the baseline data within a threshold amount.

In some instances, determining that at least one of an action or notification is associated with the employee further comprises searching an employee database for actions or notifications associated with the baseline data that matched with the biometric data.

In some instances, the actions or notifications comprise at least one of documents to sign, surveys to complete, training sessions or compliance attestation to schedule or complete, engagement actions to perform, communications to transmit, recognition events, performance management processes, announcement notifications, birthday notifications, or work anniversary notifications.

Another aspect of the disclosure is directed to a non-transitory computer readable medium for storing instructions that, when executed by one or more processors, cause the one or more processors to perform operations for providing actions or notifications to an employee clocking in or clocking out, the operations comprising: receiving biometric data associated with the employee; verifying an identity of the employee using the biometric data; determining that at least one of an action or notification is associated with the employee based on the biometric data; and outputting the action or notification.

### BRIEF DESCRIPTION OF THE DRAWINGS

FIG. 1 depicts a block diagram of an example environment for a dynamic attendance system according to aspects of the disclosure.

FIG. 2 depicts an example scenario in which an employee clocks in using the dynamic attendance system according to aspects of the disclosure.

FIG. 3 depicts a block diagram of an example dynamic attendance system according to aspects of the disclosure.

FIG. 4 depicts a flow diagram of an example process for providing actions and/or notifications to an employee clocking in or clocking out according to aspects of the disclosure.

FIG. 5 depicts a flow diagram of an example process for when an individual attempting to clock in or clock out cannot be verified according to aspects of the disclosure.

FIG. 6 depicts a flow diagram of an example process for providing a confirmation to an employee clocking in or clocking out when no actions and/or notifications are present according to aspects of the disclosure.

### DETAILED DESCRIPTION

The technology relates generally to interweaving attendance tracking of employees with other operational and/or administrative actions using a dynamic attendance system and working time monitoring system. The dynamic attendance system includes a biometric scanner and an employee database. The biometric scanner identifies the employee clocking in and clocking out as well as the time that employee clocked in and clocked out. The biometric scanner can include facial identification, thumbprint identification, and/or any other biometric verification. The biometric scanner can reduce fraudulent time entry, as employees must be present in order to be identified through biometrics.

The employee database stores information about employees for outputting actions or notices to the employee clocking in or clocking out. The dynamic attendance system can be configured to check for certain actions or notices in the employee database when an employee clocks in or clocks out. An employer or manager can provide these actions or notices. The actions or notices may differ depending on the particular employee clocking in or clocking out. If an action or notice is required for an employee identified as clocking in or clocking out, that action or notice is output to the employee. For example, once the employee clocks in using the biometric scanner, a document may be output that the employee needs to sign, such as an arbitration agreement, tax form, insurance form, etc. As another example, once the employee clocks in, a survey may be output for the employee to complete. The survey may inquire about employee sentiment with respect to their work or supervisor or inquire about any other feedback, as examples. As yet another example, once the employee clocks in using the biometric scanner, a notice may be output to the employee, such as congratulating the employee on a work anniversary, their birthday, etc. The employee database can reduce memory usage by requiring less storage space for employee information, as the employee database can include both attendance tracking for each employee as well as any action or notices particular to the respective employees, such as engagement actions to perform, communications to transmit, e.g., a message to the employee from their manager, an employee recognition event, e.g., for good attendance or behavior, and/or performance management process, e.g., asking the employee to perform a self-review.

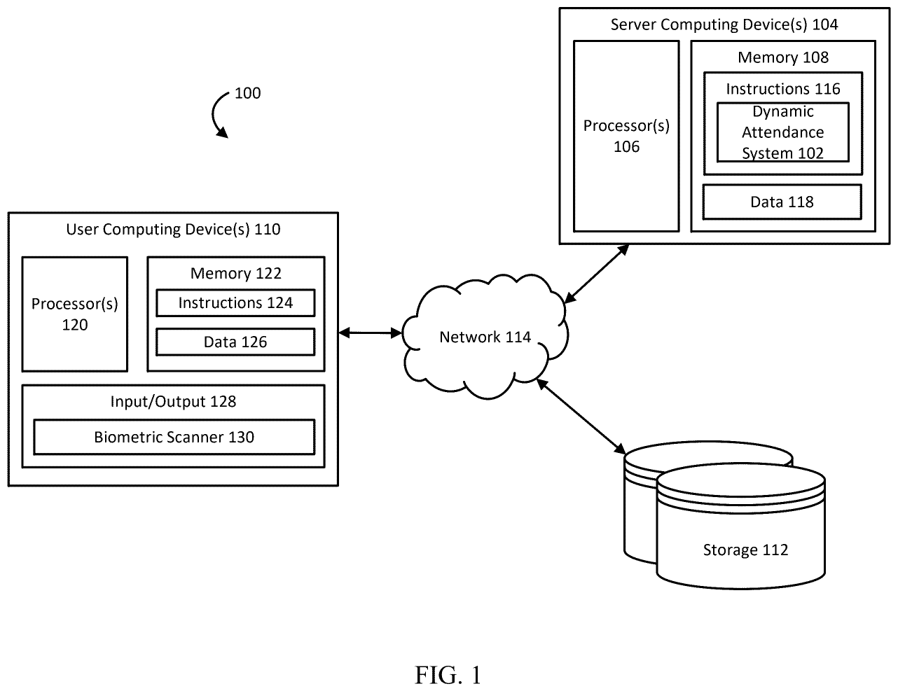

FIG. 1 depicts a block diagram of an example environment 100 for implementing a dynamic attendance system 102. The dynamic attendance system 102 can be implemented on one or more server computing devices 104 having one or more processors 106 and memory 108 in one or more locations. The server computing devices 104 can be communicatively coupled to one or more user computing devices 110 and/or one or more storage media 112 over a network 114.

The storage media 112 can be one or more databases, including a combination of volatile and non-volatile memory. The storage media 112 can be at the same or different physical locations than the server and user computing devices 104, 110. For example, the storage devices 112 can include any type of transitory or non-transitory computer readable medium capable of storing information, such as a hard-drive, solid state drive, tape drive, optical storage, memory card, ROM, RAM, DVD, CD-ROM, write-capable, and read-only memories.

The server and user computing devices 104, 110 can be capable of direct and indirect communication over the network 114. For example, using a network socket, the user computing devices 110 can connect to a service of the server computing devices 104 through an Internet protocol. The server and user computing devices 104, 110 can set up listening sockets that may accept an initiating connection for sending and receiving information. The network 114 can include various configurations and protocols including the Internet, World Wide Web, intranets, virtual private networks, wide area networks, local networks, and/or private networks using communication protocols. The network 114 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 114, in addition, or alternatively, can also support wired connections between the server and user computing devices 104, 110, including over various types of Ethernet connections.

Although a single server computing device 104 and user computing device 110 are depicted in FIG. 1, the environment 100 can include a variety of different configurations and quantities of computing devices, including paradigms for sequential or parallel processing or a distributed network of multiple devices.

The server computing device 104 can include one or more processors 106 and memory 108. The memory 108 can store information accessible by the processors 106, including instructions 116 that can be executed by the processors 106. The memory 108 can also include data 118 that can be retrieved, manipulated, or stored by the processors 106. The memory 108 can be a type of transitory or non-transitory computer readable medium capable of storing information accessible by the processors 106, such as volatile and non-volatile memory. The processors 106 can include one or more central processing units (CPUs), graphic processing units (GPUs), field-programmable gate arrays (FPGAs), and/or application-specific integrated circuits (ASICs).

The instructions 116 can include one or more instructions that, when executed by the processors 106, cause the one or more processors to perform actions defined by the instructions 116. The instructions 116 can be stored in object code format for direct processing by the processors 106, or in other formats including interpretable scripts or collections of independent source code modules that are interpreted on demand or compiled in advance. The instructions 116 can include instructions for implementing the dynamic attendance system 102 as described herein for generating additional actions and/or information for an employee clocking in or clocking out. The dynamic attendance system 102 can be executed using the processors 106, and/or using other processors remotely located from the server computing device 104.

The data 118 can be retrieved, stored, or modified by the processors 106 in accordance with the instructions 116. The data 118 can be stored in computer registers, in a relational or non-relational database as a table having a plurality of different fields and records, or as JSON, YAML, proto, or XML documents. The data 118 can also be formatted in a computer-readable format such as, but not limited to, binary values, ASCII, or Unicode. Moreover, the data 118 can include information sufficient to identify relevant information, such as numbers, descriptive text, proprietary codes, pointers, references to data stored in other memories, including other network locations, or information that is used by a function to calculate relevant data.

The user computing device 110 can be configured similarly to the server computing device 104, with one or more processors 120, memory 122, instructions 124, and data 126. The user computing device 110 can also include a user input/output 128. The user input/output 128 can include any appropriate mechanism or technique for receiving input from a user, such as keyboard, mouse, mechanical actuators, soft actuators, touchscreens, microphones, cameras, and/or sensors. The user input/output 128 can also include any appropriate mechanism or technique for providing information to a user, such as displays or other visual outputs, speakers, transducers, or other audio outputs, and/or haptic interfaces or other tactile outputs. The user input/output 128 can be implemented to display at least a portion of data received from the server computing device 104 as part of an interface between the user computing device 110 and the server computing device 104. The user input/output 128 can include a biometric scanner 130 configured to scan one or more aspects of a user, such as eyes, face, and/or fingerprints, to recognize the user being scanned. The biometric scanner 130 can utilize any user recognition technique for identifying the user.

Although FIG. 1 illustrates the processors 106, 120 and the memories 108, 122 as being respectively within the server and user computing devices 104, 110, components described herein can include multiple processors and memories that can operate in different physical locations and not within the same computing device. For example, some of the instructions 116, 124, and data 118, 126 can be stored on a removable SD card and others within a read-only computer chip. Some or all of the instructions 116, 124 and data 118, 126 can be stored in a location physically remote from, yet still accessible by, the processors 106, 120. Similarly, the processors 106, 120 can include a collection of processors that can perform concurrent and/or sequential operations. The server and user computing devices 104, 110 can each include one or more internal clocks providing timing information, which can be used for time measurement for operations and programs run by the server and user computing devices 104, 110.

The server computing device 104 can be configured to receive requests to process data from the user computing device 110. For example, the environment 100 can be part of a computing platform configured to provide a variety of services to users, through various user interfaces and/or application programming interfaces (APIs) exposing the platform services. The variety of services can include verifying employees clocking in or clocking out and providing the employees with additional actions and/or notices when they clock in or clock out. The user computing device 110 can transmit input data. The dynamic attendance system 102 can receive the input data, and in response, generate output data including prompts for the user with respect to the additional actions and/or notices as the user is clocking in or clocking out.

In operation, the dynamic attendance system 102 may receive a request to identify an employee attempting to clock in or clock out. The request can be provided based on receiving biometric information from the biometric scanner of the user computing device 110. Upon receiving the request, the dynamic attendance system 102 can receive input data and process the input data to verify the employee based on the biometric information as well as determine whether additional actions and/or notices should be provided to the employee. The dynamic attendance system 102 can generate, as output data, a confirmation that the employee is verified as well as any additional actions and/or notice for the employee. The output data can be output to the user computing device 110 and/or storage media 112.

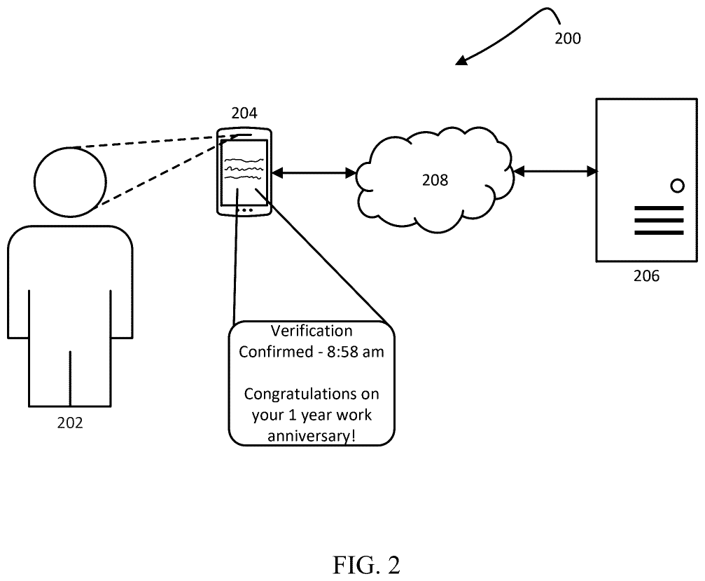

FIG. 2 depicts a diagram of an example use case scenario 200 in which an employee 202 is clocking in at their place of employment. The employee 202 clocks in at a user device 204 connected to a server device 206 over a network 208. The user device 204, server device 206, and network 208 can respectively correspond to the user device 110, server device 104, and network 114 as depicted in FIG. 1.

The employee 202 can initiate the clock in by pressing a button or using a touchpad on the user device 204 and/or providing identification information to the user device, such as an employee name and/or employee identification number. The user device 204 can scan the employee 202 for biometric information to verify the identity of the employee 202. For example, the user device 204 can include facial recognition technology via a camera and/or fingerprint recognition technology via a sensor for collecting the biometric information. The user device 204 can send the biometric information over the network 208 to the server device 206 for identity verification. For example, the server device 206 can compare the collected biometric information with baseline information about the employee to determine whether the collected biometric information matches the baseline information within a threshold amount. If the collected biometric information meets the threshold amount, then the employee identity can be verified. The server device can enter a timestamp when the employee was verified to represent the employee clocking in and send that verification and timestamp to the user device to be output as a confirmation. If the collected biometric information does not meet the threshold amount, the server device 206 may send an error notification to the user device 204 that the employee cannot be verified. The employee 202 may then attempt to be verified again.

Assuming the employee 202 is verified, the server device 206 can further determine whether additional actions and/or notifications should be provided to the employee 202 while they are clocking in. The server device 206 can parse an employee database for any actions and/or notifications associated with the employee 202. For example, the server device 206 can use the collected biometric information to determine if any actions and/or notifications are associated with the baseline information about the employee. The actions and/or notifications can include documents to sign, surveys to complete, training sessions needed to be scheduled, engagement actions to perform, communications to transmit, recognition events, performance management processes, announcement notifications, birthday notifications, and/or work anniversary notifications, as examples. The actions and/or notifications can be added to the employee database by an employer or manager of the employee 202. If the server device 206 finds any additional actions and/or notifications, the server device 206 can send them to the user device 204 to be output to the employee 202. As depicted, the user device 204 outputs the verification and timestamp as well as a congratulatory message that the employee has been working for a year.

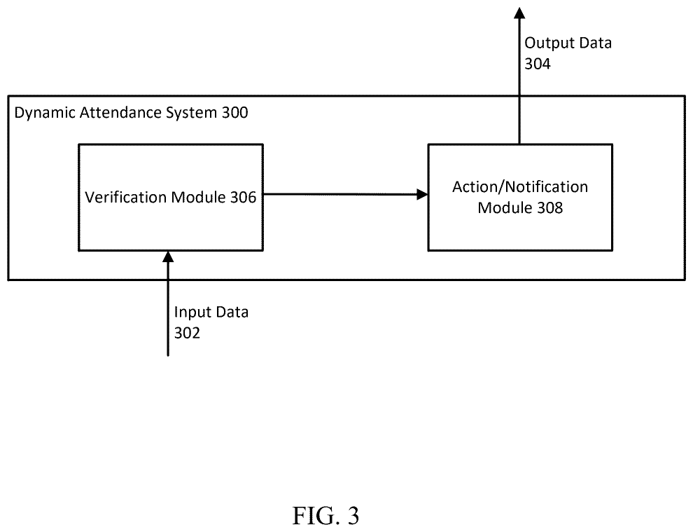

FIG. 3 depicts a block diagram of an example dynamic attendance system 300 for verifying employee identification and providing additional actions and/or notifications to an employee when that employee clocks in or clocks out. The dynamic attendance system 300 can be implemented across one or more computing devices in one or more locations, such as the dynamic attendance system 102 as depicted in FIG. 1.

The dynamic attendance system 300 can be configured to receive input data 302. For example, the dynamic attendance system 300 can receive the input data 302 as part of a call to an application programming interface (API) exposing the dynamic attendance system 300 to one or more computing devices over a network. As another example, the dynamic attendance system 300 can receive the input data 302 from a storage medium, such as remote storage connected to the one or more computing devices over the network. As yet another example, the dynamic attendance system 300 can receive the input data 302 from a user interface on a client computing device coupled to the dynamic attendance system 300 over the network.

The input data 302 can include biometric data for verifying the identity of an employee. The biometric data can include features of a person that can be used for verification, such as eyes, face, and/or fingerprints as examples. The biometric data can be received from a biometric scanner that scans an employee when that employee clocks in or clocks out. The input data 302 can further include queries or prompts from an employee to be verified for clocking in or clocking out. The input data 302 can also include metadata, such as location data or timestamps corresponding to where and when the employee clocks in or clocks out.

From the input data 302, the dynamic attendance system 300 can be configured to output one or more results generated as output data 304, such as a confirmation that an employee clocked in or clocked out as well as any additional actions and/or notifications for that employee. For example, the dynamic attendance system 300 can be configured to provide the output data 304 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. As another example, the dynamic system 300 can be configured to forward the output data 304 to one or more other computing devices configured for translating the output data 304 into an executable program written in a computer programming language and optionally as part of a framework for verifying employees and providing additional actions and/or notifications during clocking in or clocking out. The dynamic attendance system 300 can also be configured to send the output data 304 to a storage device for storage and later retrieval, such as a secure cloud storage platform. The dynamic attendance system 300 can further be configured to send the output data 304 for display, such as on a display of a user device.

The dynamic attendance system 300 can include a verification module 306 and an action/notification module 308. The verification module 306 and action/notification module 308 can be implemented as one or more computer programs and/or specially configured electronic circuitry.

The verification module 306 can be configured to verify the identity of an employee clocking in or clocking out based on the input data 302. The verification module 306 can determine whether the biometric data received as part of the input data 302 matches baseline data stored to represent the employee. For example, the verification module 306 can compare the biometric data with the baseline data to determine whether the biometric data matches the baseline data within a threshold amount. The threshold amount can be a score or percentage as examples, such as biometric data matching 95% or greater to the baseline data to verify the employee. The baseline data can be historical biometric data of the employee previously collected and stored in an employee database, such as when the employee is hired. The baseline data can be periodically updated with newer biometric data to reduce potential errors during verification due to stale data.

If the biometric data matches the baseline data within the threshold amount, the verification module 306 verifies the identity of the employee clocking in or clocking out. The verification module 306 also determines and enters the time that the employee was verified or initiated verification to be utilized as the clock in or clock out time. If the biometric data does not match the baseline data within the threshold amount, the verification module 306 does not verify the identity of the employee. Rather, the verification module 306 may determine to output an error message and prompt the employee to attempt verification again. If the biometric data continues to not match the baseline data after a predetermined number of attempts, the verification module 306 may determine to output a message that the employee should contact their supervisor. The verification module 306 may also shut down to prevent further verification attempts. Even if the verification module 306 does not verify the identity of the employee, the verification module 306 may still enter that time that the employee was not verified. Thus, if a subsequent verification attempt is successful, the verification module 306 can use the earlier time for the employee clocking in or clocking out.

In response to the verification module 306 verifying the employee, the action/notification module 308 can be configured to provide additional actions and/or notifications to the employee after they clock in or clock out. The action/notification module 308 can determine whether to prompt the employee with additional actions and/or notifications based on the biometric data. Example actions and/or notifications can include documents to sign, surveys to complete, training sessions to be scheduled or completed, birthday notifications, and/or work anniversary notifications. The actions and/or notifications can be input to the employee database by an employer or manager. The actions and/or notifications can be input through rules for the action/notification module 308, such as to output a notification to the employee after certain milestones are met or to output that employees with less than 6 months experience need to complete certain training sessions. The employer or manager can also input to the employee database actions that need to be completed by particular employees, such as if certain documents like arbitration agreements are required to be signed.

The action/notification module 308 can search the employee database to determine if there are any actions and/or notifications associated with baseline data matching the biometric data of the employee, such as based on the input provided by the employer or manager. If the action/notification module 308 finds any actions and/or notifications associated with the baseline data, the action/notification module 308 can provide them to the employee. The actions and/or notifications can be output as part of a confirmation verifying when the employee clocked in or clocked out. For example, the action/notification module 308 can determine the employee needs to complete a training session based on searching the employee database. In response to this determination, the action/notification module 308 can output a confirmation message to the employee that they clocked in and that they need to schedule a training session with their manager. If the action/notification module 308 does not find any actions and/or notifications associated with the baseline data, the action/notification module 308 can simply output the confirmation verifying when the employee clocked in or clocked out.

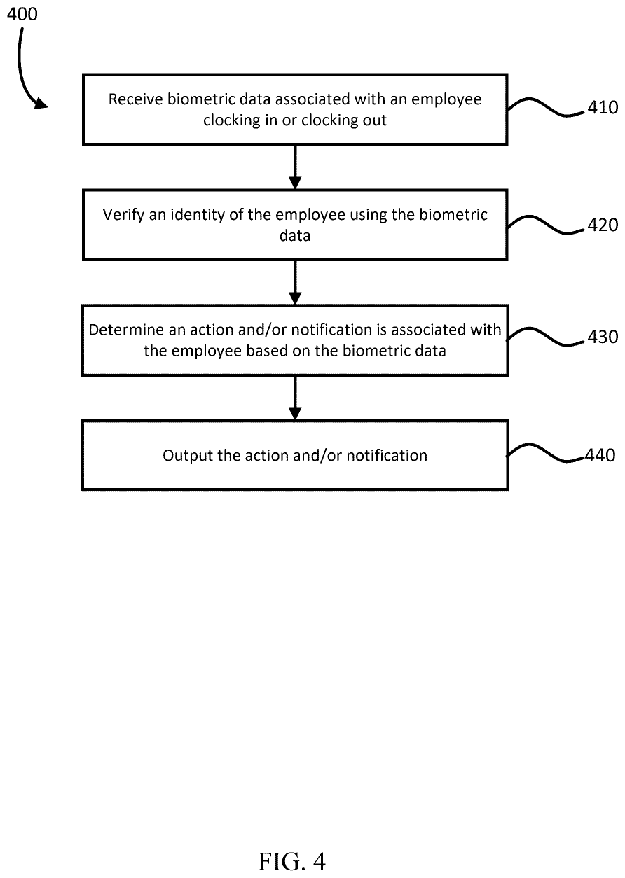

FIG. 4 depicts a flow diagram of an example process 400 for providing actions and/or notifications to an employee clocking in or clocking out. The example process 400 can be performed on a system of one or more processors in one or more locations, such as the dynamic attendance system 300 as depicted in FIG. 3.

As shown in block 410, the dynamic attendance system 300 receives biometric data associated with the employee. The biometric data can include ocular data, facial data, and/or fingerprint data respectively for ocular recognition, facial recognition, and/or fingerprint recognition. The dynamic attendance system 300 can further receive metadata including a timestamp and/or location respectively for when and/or where the employee is clocking in or clocking out.

As shown in block 420, the dynamic attendance system 300 verifies an identity of the employee using the biometric data. The dynamic attendance system 300 can compare the biometric data with baseline data representing the employee. The dynamic attendance system 300 can determine that the biometric data matches the baseline data within a threshold amount. The baseline data can include historical biometric data associated with the employee. In some instances, the dynamic attendance system 300 may verify the identity of an employee using an image captured of the employee when clocking in or clocking out. In this regard, the image of the employee may be used in conjunction with the biometric data, such that both the captured image and biometric data are compared to historical biometric data (e.g., past pictures and biometric data associated with the employee. In some instances, the dynamic attendance system 300 may verify the identity of an employee using only the captured image without biometric data. The dynamic attendance system 300 can enter a timestamp when the identity was verified to represent a time the employee clocked in or clocked out.

As shown in block 430, the dynamic attendance system 300 determines an action and/or notification is associated with the employee based on the biometric data. The dynamic attendance system 300 can search an employee database for actions and/or notifications associated with the baseline data that matched with the biometric data. The actions and/or notifications can include documents to sign, surveys to complete, training sessions or compliance attestation to schedule or complete, engagement actions to perform, communications to transmit, recognition events, performance management processes, announcement notifications, birthday notifications, and/or work anniversary notifications. The action and/or notification may also include detection of fraudulent behavior with respect to the employee clocking in or clocking out.

As shown in block 440, the dynamic attendance system 300 outputs the action and/or notification. The action and/or notification can be output as part of a confirmation that the employee clocked in or clocked out.

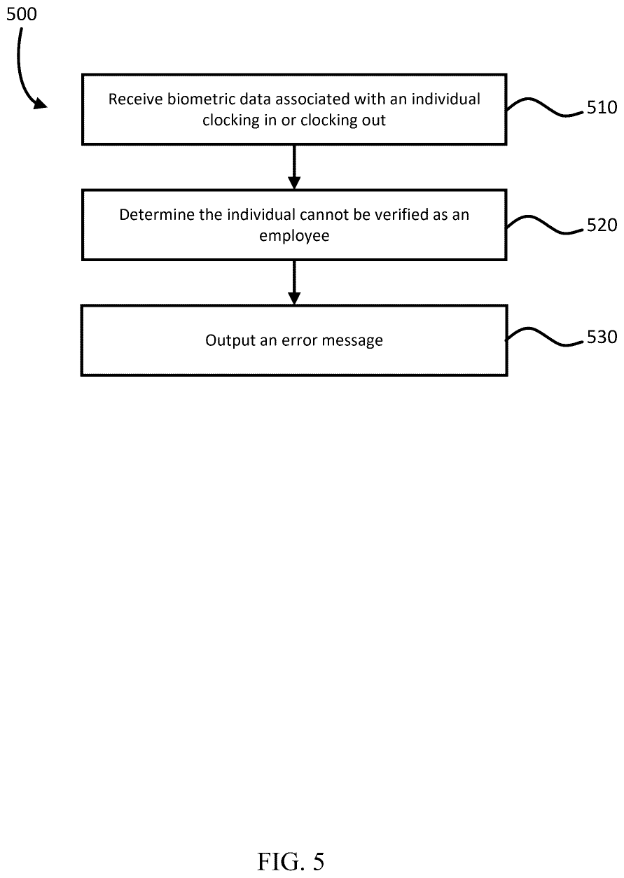

FIG. 5 depicts a flow diagram of an example process 500 for when an individual attempting to clock in or clock out cannot be verified. The example process 500 can be performed on a system of one or more processors in one or more locations, such as the dynamic attendance system 300 as depicted in FIG. 3.

As shown in block 510, the dynamic attendance system 300 receives biometric data associated with the individual.

As shown in block 520, the dynamic attendance system 300 determines the individual cannot be verified as an employee. The dynamic attendance system 300 can compare the biometric data with baseline data and determine that the biometric data does not match the baseline data within a threshold amount.

As shown in block 530, the dynamic attendance system 300 outputs an error message that the identity of the individual cannot be verified. If multiple attempts to verify the individual result in the same determination that the individual cannot be verified, the dynamic attendance system 300 can output a message to contact a supervisor. The dynamic attendance system 300 can further shut down to prevent further attempts to clock in or clock out.

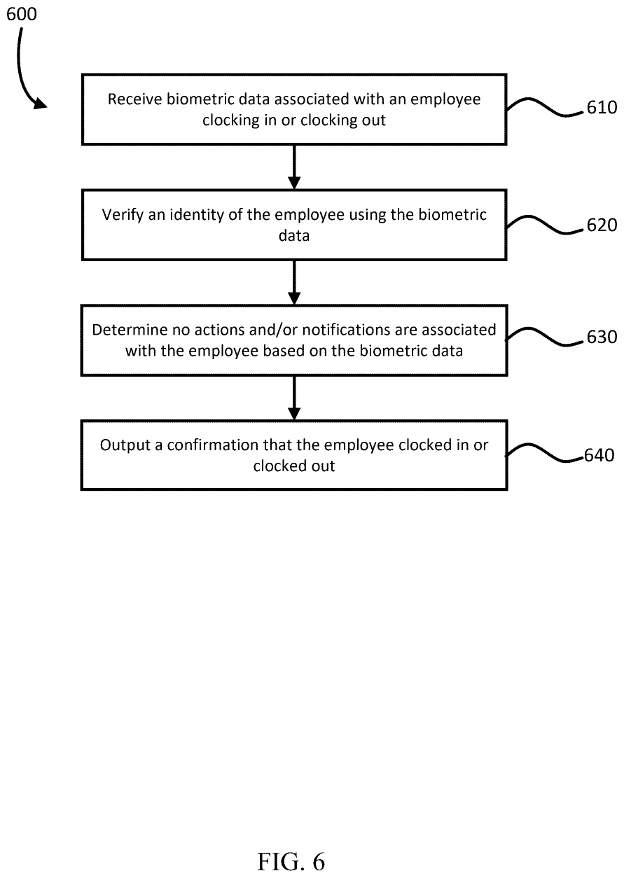

FIG. 6 depicts a flow diagram of an example process 600 for providing a confirmation to an employee clocking in or clocking out when no actions and/or notifications are present. The example process 600 can be performed on a system of one or more processors in one or more locations, such as the dynamic attendance system 300 as depicted in FIG. 3.

As shown in block 610, the dynamic attendance system 300 receives biometric data associated with the employee.

As shown in block 620, the dynamic attendance system 300 verifies an identity of the employee using the biometric data.

As shown in block 630, the dynamic attendance system 300 determines there are no actions and/or notifications associated with the employee based on the biometric data. The dynamic attendance system 300 can search an employee database for actions and/or notifications associated with the baseline data that matched with the biometric data and find no results.

As shown in block 640, the dynamic attendance system 300 outputs a confirmation that the employee clocked in or clocked out. The confirmation does not include any actions and/or notifications.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for providing actions or notifications to an employee clocking in or clocking out, the method comprising:
receiving, by one or more processors, biometric data associated with the employee;
verifying, by the one or more processors, an identity of the employee using the biometric data;
determining, by the one or more processors, that at least one of an action or notification is associated with the employee based on the biometric data; and
outputting, by the one or more processors, the action or notification.

2. The method of claim 1, wherein the biometric data comprises at least one of ocular data, facial data, or fingerprint data.

3. The method of claim 1, further comprising receiving, by the one or more processors, metadata comprising at least one of a timestamp or location for when or where the employee is clocking in or clocking out.

4. The method of claim 1, wherein the action or notification is output as part of a confirmation that the employee clocked in or clocked out.

5. The method of claim 1, wherein verifying the identity of the employee comprises comparing the biometric data with baseline data representing the employee.

6. The method of claim 5, wherein verifying the identity of the employee comprises determining biometric data matches the baseline data within a threshold amount.

7. The method of claim 5, wherein determining that at least one of an action or notification is associated with the employee further comprises searching an employee database for actions or notifications associated with the baseline data that matched with the biometric data.

8. The method of claim 5, wherein the baseline data comprises historical biometric data associated with the employee.

9. The method of claim 1, wherein verifying the identity of the employee comprises entering a timestamp when the identity was verified to represent a time the employee clocked in or clocked out.

10. The method of claim 1, further comprising:
receiving, by the one or more processors, second biometric data associated with an individual;
comparing, by the one or more processors, the second biometric data with baseline data; and
determining, by the one or more processors, that the second biometric data does not match the baseline data within a threshold amount.

11. The method of claim 10, further comprising outputting, by the one or more processors, an error message that an identity of the individual cannot be verified.

12. The method of claim 1, wherein the actions or notifications comprise at least one of documents to sign, surveys to complete, training sessions or compliance attestation to schedule or complete, engagement actions to perform, communications to transmit, recognition events, performance management processes, announcement notifications, birthday notifications, or work anniversary notifications.

13. The method of claim 1, wherein the actions or notifications comprise a detection of fraudulent behaviors with respect to the employee clocking in or clocking out.

14. The method of claim 1, further comprising:
receiving, by one or more processors, third biometric data associated with a second employee;
verifying, by the one or more processors, an identity of the second employee using the third biometric data;
determining, by the one or more processors, there are no actions or notifications associated with the second employee based on the third biometric data; and
outputting, by the one or more processors, a confirmation that the second employee clocked in or clocked out.

15. A system comprising:
one or more processors; and
one or more storage devices coupled to the one or more processors and storing instructions that, when executed by the one or more processors, cause the one or more processors to perform operations for providing actions or notifications to an employee clocking in or clocking out, the operations comprising:
receiving biometric data associated with the employee;
verifying an identity of the employee using the biometric data;
determining that at least one of an action or notification is associated with the employee based on the biometric data; and
outputting the action or notification.

16. The system of claim 15, wherein the biometric data comprises at least one of ocular data, facial data, or fingerprint data.

17. The system of claim 15, wherein verifying the identity of the employee comprises:
comparing the biometric data with baseline data representing the employee; and
determining biometric data matches the baseline data within a threshold amount.

18. The system of claim 17, wherein determining that at least one of an action or notification is associated with the employee further comprises searching an employee database for actions or notifications associated with the baseline data that matched with the biometric data.

19. The system of claim 15, wherein the actions or notifications comprise at least one of documents to sign, surveys to complete, training sessions or compliance attestation to schedule or complete, engagement actions to perform, communications to transmit, recognition events, performance management processes, announcement notifications, birthday notifications, or work anniversary notifications.

20. A non-transitory computer readable medium for storing instructions that, when executed by one or more processors, cause the one or more processors to perform operations for providing actions or notifications to an employee clocking in or clocking out, the operations comprising:
receiving biometric data associated with the employee;
verifying an identity of the employee using the biometric data;
determining that at least one of an action or notification is associated with the employee based on the biometric data; and
outputting the action or notification.
